(19) United States
(12) Patent Application Publication
(10) Pub. No.: US 2015/0042470 A1
(43) Pub. Date: Feb. 12, 2015

(54) NON-BATTERY OPERATED PERSONAL EMERGENCY RESPONSE SYSTEM

(71) Applicant: ZF Friedrichshafen AG, Friedrichshafen (DE)

(72) Inventors: Ronald Muetzel, Hawthorn Woods, IL (US); Thomas Roesch, Friedrichshafen (DE)

(73) Assignee: ZF Friedrichshafen AG, Friedrichshafen (DE)

(21) Appl. No.: 13/961,271

(22) Filed: Aug. 7, 2013

(51) Int. Cl. G08B 25/01

(52) U.S. Cl. CPC G08B 25/016
USPC 340/539.12; 340/539.11

(57) ABSTRACT

A personal emergency response system may include an actuator with a generator that creates electrical energy upon activation or motion of the switch. The system may utilize the electrical energy to transmit an emergency alert signal to a receiver based on characteristics of the switch, such as movement of the switch, location of the switch, and time of sending the signal.

### BACKGROUND

Emergency response devices allow users to notify others that an emergency situation is occurring and that assistance is required. Emergency response devices may be placed at various locations within a user's home to allow the user to access the device if any emergency occurs. Some emergency response devices may be worn by the user to provide the user with access to the device if the user is unable to move. The emergency response devices may send an alert signal through wired or wireless connections. Emergency response devices are activated by the user through a button located on the device. The device does not transmit a signal until the user depresses the button indicating that an emergency alert signal should be transmitted. The emergency response devices located in the user's home may be powered through the home's electrical circuitry or the devices may be battery powered. The emergency response devices worn by the user are battery operated. Battery operated emergency response devices are only able to send emergency alert signals if the batteries have sufficient charge to power the device. Further, the device will not transmit an alert signal if the user is incapacitated and is unable to trigger the device.

Therefore, there is a need for an emergency response system that can operate independently of a user's instruction and without the use of batteries.

### SUMMARY OF THE INVENTION

The descriptions below include systems and methods for transmitting signals from non-battery powered personal emergency devices.

According to one aspect a personal emergency response system may attached to a user and may comprise an actuator coupled to a generator. The personal emergency response system may also comprise a transmitter connected to the generator. The generator may be operable to generate electrical energy, without the use of a battery, to power the transmitter upon movement of the actuator. The transmitter may be operable to send a signal wirelessly upon movement of the actuator. The personal emergency response system may also comprise a remote receiver that is operable to receive the signal from the transmitter, wherein the receiver interprets the signal based on at least one characteristic of the actuator.

According to another aspect a method of operating a personal emergency response system attached to a user may comprise generating electrical energy upon movement of an actuator that is attached to a user; powering a transmitter with the electrical energy; sending a signal wirelessly from the transmitter; receiving the signal in a remote receiver; and interpreting the signal in the remote receiver based on at least one characteristic of the actuator.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The exemplary systems and methods described below may be more fully understood by reading the following description in conjunction with the drawings, in which

FIG. 1A is a cross section of an example of a radio-controlled switch according to an exemplary personal emergency response system;

FIG. 1B is a schematic diagram of an example of a radio-controlled switch according to an exemplary personal emergency response system;

FIG. 2 is a diagram of an exemplary personal emergency response system;

FIG. 3 is a diagram of another exemplary personal emergency response system;

FIG. 4 is a diagram of another exemplary personal emergency response system;

FIG. 5 is a diagram of another exemplary personal emergency response system; and

FIG. 6 is a flow diagram of a method for operating an exemplary personal emergency response system.

### DETAILED DESCRIPTION

The exemplary systems and methods as described herein may take a number of different forms. Not all of the depicted components may be required and some implementations may include additional, different, or fewer components from those expressly described in this disclosure. Variations in the arrangement and type of the components may be made without departing from the spirit or scope of the claims as set forth herein.

A non-battery powered personal emergency response system may produce electrical energy when activated or when moved. The system may utilize the electrical energy to transmit a signal to a remote receiver. By producing its own electrical energy, the system may advantageously be available to transmit a signal to a remote receiver without regard to an external power source, such as a battery. The signal may be an indication of an emergency situation or the signal may relay other information to the receiver, such as medical information.

A radio-controlled switch, particularly a snap-action switch, with an antenna, a transmitter assembly, and a generator may be used in the personal emergency response system. The antenna may be electrically connected to the transmitter assembly to emit a signal that can be generated by the transmitter assembly. The transmitter assembly may be located on a circuit carrier and the antenna may be held on a carrier substrate within the radio-controlled switch that is separate from the circuit carrier. An example radio-controlled switch may be found in commonly-assigned U.S. patent application Ser. No. 13/636,306, the contents of which are incorporated herein by reference in their entirety. An example generator may be found in commonly-assigned U.S. patent application Ser. Nos. 13/636,307 and 13/636,309, the contents of which are incorporated herein by reference in their entirety.

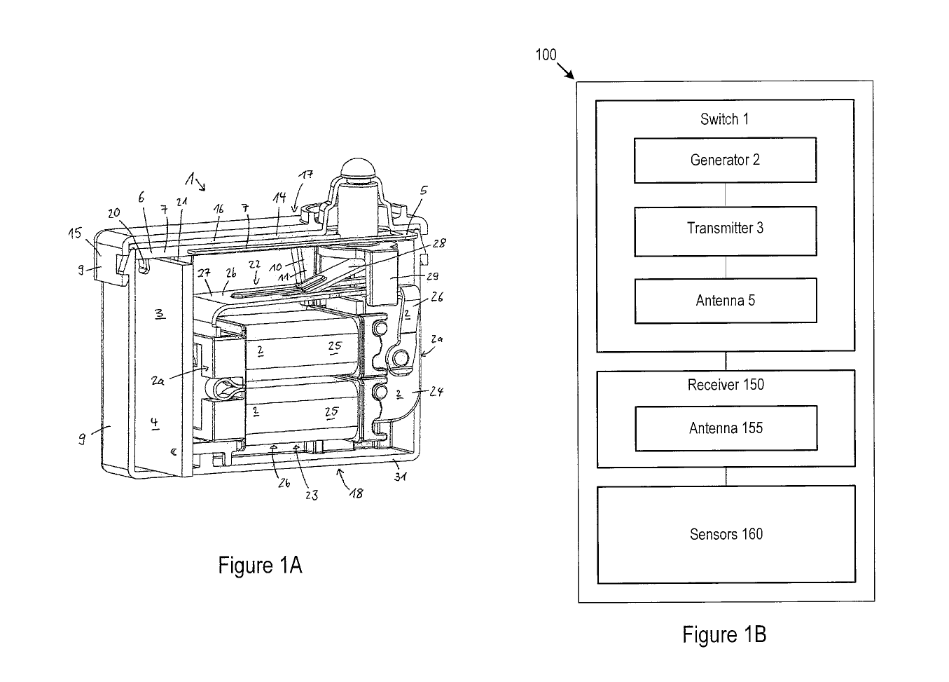

FIG. 1A shows the cross section of exemplary switch 1, which is particularly implemented as an energy-independent radio-controlled switch. Such an energy-independent switch draws its energy from the actuation process or movement by which generator 2 of switch 1 is placed into operation. Generator 2 may be an induction generator, a piezo generator, or any other generating device. Generator 2 may provide energy to transmitter assembly 3. The energy may be buffered, for example, in a capacitor or an inductor.

Switch 1 may be any type of actuator, for example, a snap-action switch, in which a magnetic element is mechanically accelerated by a spring load during a movement of the magnetic element to reverse the polarity of the core of an induction coil of the generator. In general, switch 1 may be implemented as a monostable (one resting position), bistable (two resting positions), or metastable (stable against small changes, unstable against larger changes) radio-controlled switch. Switch 1 may be a mechanical switch, a pendulum, or a piezoelectric device.

Transmitter assembly 3 may generate a signal using the generated energy. Transmitter assembly 3 may be connected to antenna 5 such that the signal may be emitted as a radio signal from antenna 5. Transmitter assembly 3 may include circuitry to condition, modulate, or format the transmitted signal into a particular type of wireless signal. For example, the transmitter assembly may module the signal according to modulation schemes known in the art, such as FM, AM, and PM, or more sophisticated schemes such as CDMA. The transmitter assembly may advantageously condition the signal to comply with a wireless standard, such as IEEE 802.11. Transmitter assembly 3 may have circuit carrier 4, for example, in the form of a circuit board, which supports the electronics of transmitter assembly 3. Antenna 5 may be held on carrier substrate 6, for example an antenna carrier, which is separate from circuit carrier 4 of transmitter assembly 3. Circuit carrier 4 and carrier substrate 6 may be separate substrates, which may advantageous reduce interference between circuits deposed on circuit carrier 4 and antenna 5.

Generator 2 in switch 1 may be small yet still provide high energy upon actuation or movement of switch 1. Generator 2 may be a miniaturized generator 2 in the form of an induction snap generator in which magnetic element 24 is moved relative to induction coil 25. In addition, further compact generators may be used for generator 2, for example, that make use of other mechanisms for energy generation. An example is piezo generators. When generator 2 is implemented as a snap generator, a high acceleration of the magnetic element 24 between two resting points may cause a high temporal change in the magnetic flux, whereby the polarity of the generator core is reversed from the polarity of a switch in the rest position. The change in magnetic flux may cause generator 2 to generate electrical energy.

To generate electrical energy, magnet element 24 may have a permanent magnet, and at least one induction coil with a coil core. Magnet element 24 may be arranged adjacent to the induction coil, and may be movable relative to the coil core to generate a flux change in the core and generate an induction voltage by means of the induction coil. The energy generated by the flux change may be emitted or transferred to another assembly of switch 1, for example, transmitter assembly 3, or may be stored, for example, in a rechargeable battery, capacitor, or ultra-capacitor.

The movement of switch 1 may generate the force to move magnetic element 24 between the two resting points. Movement may occur in the form of, for example, a snap movement. To generate a snap movement, spring element 26 connected to magnetic element 24 may be increasingly stressed during its movement between the resting positions, until the magnetic element 24 has reached a middle point between the resting positions. Upon reaching the middle point, energy stored by the stress on spring element 26 can be used for the mechanical acceleration of magnetic element 24 towards the resting position to be assumed by means of release of spring element 26, resulting in an extremely accelerated approach of magnetic element 24 towards the core. Between the resting positions, magnetic element 24 may be moved away from contact with the flanks and moved along a suitable path, e.g. a circular arc shaped path which permits an increasing and decreasing spring stress.

Additionally or alternatively, the movement of switch 1 may generate the force to move magnetic element 24, thereby causing the generator to generate electrical energy. Movement of switch 1 from a stationary position to a non-stationary position may cause magnetic element 24 to move between resting positions, which may cause generator 2 to generate electrical energy. Similarly, continued movement of switch 1 may cause magnetic element 24 to move, and may cause generator 2 to generate electrical energy.

FIG. 1B is a schematic diagram of personal emergency response system 100. Personal emergency response system 100 may also include additional components not shown in FIG. 1B. Personal emergency response system 100 may include switch 1, receiver 150, and antenna 155. The components of personal emergency response system 100 shown in FIG. 1B may correspond in function to similarly numbered components shown in FIG. 1A. Switch 1 (which may include generator 2, transmitter 3, antenna 5), receiver 150, antenna 155, and sensors 160 may be housed within a single device, as shown in FIG. 1B, or may be housed in separate devices that are in communication with each other. Transmitter 3 and receiver 150 may be may be combined into a transceiver. Further, one of antenna 5 or antenna 155 may be unnecessary where transmitter 3 and receiver 150 may share one antenna, or where a transceiver is employed in place of transmitter 3 and receiver 150. Sensors 160 may be one more sensors to sense any physical condition or the environment or user of the device. For example, sensors 160 may include accelerometers, thermometers, heart rate monitors, or image sensors.

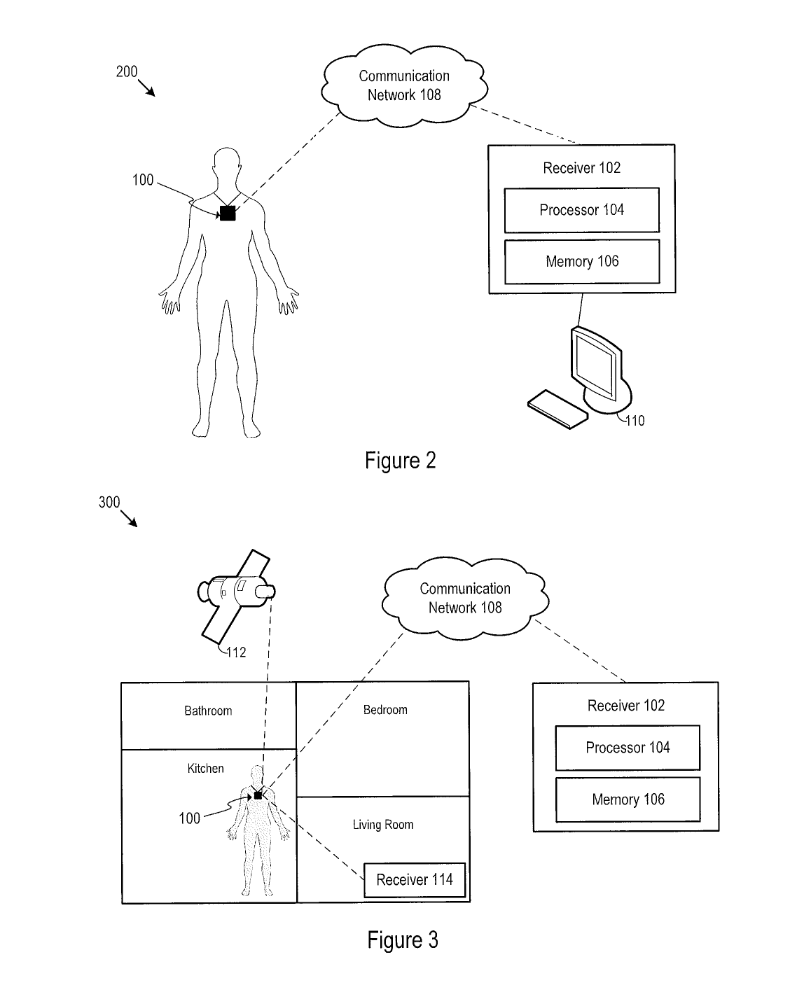

FIG. 2 is a diagram of an exemplary personal emergency response system 200. Personal emergency response system 200 may include device 100 shown and described in relation to Figure and 1B. The size and shape of device 100 shown in FIG. 2 is for illustrative purposes only. Device 100 may take any size or shape dictated by design requirements. Personal emergency response system 200 may include a receiver 102. Receiver 102 may include processor 104 and memory 106. Receiver 102 may be in communication with device 100 through communication network 108. Alternatively, receiver 102 may be a transceiver that includes capabilities to send signals to device 100. Communication network 108 may be any number of communication networks and may take any number of forms, such as a wireless network. Device 100 may communicate with receiver 102 according to any number of communication protocols, standards, networks, or topologies. As examples, device 100 may communicate across cellular networks or standards (e.g., 2G, 3G, Universal Mobile Telecommunications System (UMTS), GSM (R) Association, Long Term Evolution (LTE)™, or more), WiMAX, Bluetooth, WiFi (including 802.11a/b/g/n/ac or others), WiGig, Global Positioning System (GPS) networks, and others available at the time of the filing of this application or that may be developed in the future. Device 100 and receiver 102 may include processing circuitry, data ports, transmitters, receivers, transceivers, or any combination thereof to communicate across any of the above-listed protocols, standards, networks, or topologies. Receiver 102 may be in communication with computer 110. Computer 110 may be any known computer processing device that is capable of storing and processing commands and instructions, such as, for example, a server, computer, tablet, smartphone, or personal data assistant. Receiver 102 and computer 110 may be directly linked, as shown in FIG. 2, or may be housed in a single unit. Alternatively, receiver 102 may communicate with computer 110 through one or more communication networks, such as communication network 108, as previously described. Receiver 102 may be remote from device 100, as shown in FIG. 2, or may be attached or in close proximity to device 100.

Personal emergency response system 200 may generate electrical energy and transmit a signal when activated by the user, such as through a button, or when device 100 is moved. As previously described, generator 2 in switch 1 contained in device 100 may create electrical energy when a magnet element is moved. Generator 2 may create electrical energy when device 100 is activated by a user or when device 100 is moved. The movement required to cause device 100 to create electrical energy may be provided by a user that is attached to device 100 or that is wearing device 100. The movement may occur when the user is moving, such as when walking or performing an activity. An example user shown in FIG. 2 is wearing device 100 around their neck. Device 100 may be worn or attached to a user in any known manner, such as attached to or embedded in clothing or shoes, carried in a pocket, or worn on an appendage. The movement to cause device 100 to generate electrical energy may also be deliberately provided by the user, such as by shaking, moving, or waving device 100. Device 100 may include a mechanism to store energy that is created when device 100 is moved. The stored energy may be used by device 100 to transmit a signal when device 100 is not generating electricity, such as when device 100 is stationary. The mechanism to store energy may include a rechargeable storage battery, a capacitor, an ultra-capacitor, or other energy storage device, if the stored energy is electrical. The mechanism to store energy may include a spring if the stored energy is mechanical. Stored mechanical energy may be converted to electrical energy by generator 2. By creating its own electrical energy, device 100 may be energy independent and may not require a separate power source, such as a battery or a building's electrical circuitry. As such, device 100 may reliably operable to transmit an alert signal because it advantageously does not rely on a separate power source. In this way, device 100 may advantageously always be operable due to its lack of reliance on an external power source.

Device 100 may use the electrical energy generated by generator 2 to transmit a signal from transmitter 3 and antenna 5. Device 100 may be configured to transmit a signal when device 100 is moved. The movement to cause device 100 to transmit a signal may be the same type of movement that was previously described in relation to how device 100 generates electrical energy. Additionally or alternatively, device 100 may be configured to transmit a signal at predefined time intervals, such as every minute or every hour. The time intervals may be modified by a user or other party with access to personal emergency response system 200. Additionally or alternatively, device 100 may be configured to transmit a signal based on a combination of movement and time intervals. Using such a combination may allow device 100 to efficiently use the electrical energy created by generator 2. For example, device 100 may be configured to transmit a signal when moved and to also transmit a signal at specified time intervals when device 100 is stationary. Any other combinations of movement, non-movement, and time intervals may be used by device 100 to transmit a signal. Device 100 may be configured to transmit a signal without any instruction or command from a user, such as pressing a button. Device 100 may work independently from any user instruction.

The signals transmitted by device 100 may be received by receiver 102. The signals may be transmitted wirelessly through communication network 108, as previously described, or may be sent wireless directly from device 100 to receiver 102. Receiver 102 may receive the signals and may interpret the signals based on characteristics of device 100. Processor 104 in receiver 102 may interpret the signals based on logic or instructions stored in memory 106. Characteristics of device 100 may include, for example, the presence or absence of movement of device 100. The characteristic of movement of device 100 may include the absence of movement. Similarly, the characteristic of absence of movement of device 100 may include the presence of movement. The movement of device 100 may be the same movement as previously described in relation to device 100 creating electrical energy. Receiver 102, through processor 104 and memory 106, may interpret movement or the absence of movement of device 100 as an indication of an abnormality. As such, receiver 102 may interpret a signal transmitted from device 100 as an emergency alert or other signal requiring immediate attention. Additionally or alternatively, receiver 102 may interpret the signals from device 100 and may transmit another signal indicating an emergency alert or other signal requiring immediate attention. Receiver 102 may be in communication with other parties, such as police, hospitals, ambulances, fire departments, security services, or other emergency services.

FIG. 3 is a diagram of another exemplary personal emergency response system 300. Personal emergency response system 300 may include components previously described in reference to FIGS. 1A, 1B, and 2. Personal emergency response system 300 may include device 100, a remote receiver 102 or a local receiver 114. Local receiver 114 may have similar functions and capabilities as previously described in reference to receiver 102. Local receiver 114 may also include transmit capabilities. Including local receiver 114 that is in communication with device 100 may reduce the signal strength required for a signal transmitted from device 100 to reach a receiver. Reducing the required signal strength may allow device 100 to transmit signals more often, more efficiently, or with more information included in the signal. Including local receiver 114 may also eliminate the need for communication network 108 to transmit the signal from device 100 to a receiver, which may increase the reliability of personal emergency response system 300.

Receiver 102 in personal emergency response system 300 may interpret signals transmitted by device 100 based on additional characteristics of device 100, such as the location of device 100. Depending on the location of device 100, receiver 102 may interpret signals transmitted by device 100 differently. For example, a signal indicating movement of device 100 in a location such as user's kitchen, as shown in FIG. 3, may not be interpreted as an emergency alert requiring attention. However, a signal indicating lack of movement in a user's bathroom may be interpreted as an emergency that requires immediate attention. This example of interpreting a signal based on a combination of the characteristics of movement and location is merely one example. A large variety of combinations of characteristics are possible and such combinations should be interpreted as included within the scope of this specification. As previously described, receiver 102 may alert other parties of the emergency situation depending on its interpretation of the signal. The characteristic defined by the location of device 100 may not be limited to particular rooms within a user's home or dwelling, as shown in FIG. 3. The location of device 100 may be characterized by zones that are defined in any space, such as floors of a building, areas of a property, locations in outdoor spaces, etc. The zones may be defined and modified by the user or other parties. Personal emergency response system 300 may determine the location of device 100 by any known means, such as by communication with global positioning satellites 112, as shown in FIG. 3, or by other navigation, triangulation, or signal location methods.

Receiver 102 in personal emergency response system 300 may interpret signals transmitted by device 100 based on additional characteristics of device 100, such as the time a signal is transmitted from device 100 or the time a signal is received by receivers 102, 114. Depending on the time device 100 transmits or receivers 102, 114 receive a signal, receivers 102, 114 may interpret the signal transmitted by device 100 differently. For example, a signal indicating absence of movement of device 100 during normal sleeping hours may not be interpreted as an emergency alert requiring attention. However, a signal indicating absence of movement of device 100 during normal waking hours may be interpreted as an emergency that requires immediate attention. This example of interpreting a signal based on a combination of the characteristics of movement and time is merely one example. A large variety of combinations of characteristics are possible and such combinations should be interpreted as included within the scope of this specification. As previously described, receiver 102 may alert other parties of the emergency situation depending on its interpretation of the signal. The characteristic of time may not be limited to time of day, but may include any other expressions of time, such as, for example, particular ranges of time, or before or after certain times. Additionally or alternatively, the time characteristic of device 100 could include a duration of movement or absence of movement. For example, a period of prolonged movement or absence of movement could be interpreted as an emergency alert that requires attention. The time characteristics used to interpret signals from device 100 may be modified by a user or other party.

Receiver 102 in personal emergency response system 300 may interpret signals transmitted by device 100 based on combinations of characteristics of device 100, such as for example, movement, location, and time. Depending on the location and time of movement or absence of movement of device 100, receiver 102 may interpret signals transmitted by device 100 differently. For example, a signal indicating a period of prolonged absence of movement of device 100 that is located outdoors may be interpreted as an emergency alert requiring attention. However, a signal indicating a period of prolonged absence of movement of device 100 that is located in a user's bedroom may not be interpreted as an emergency alert. This example of interpreting a signal based on a combination of the characteristics of movement, location, and time is merely one example. A large variety of combinations of characteristics are possible and such combinations should be interpreted as included within the scope of this specification.

The characteristics and combinations of characteristics of device 100 that are used to interpret signals transmitted by device 100 may be stored in memory 106 in receivers 102, 114 and may be modified based on the particular user of personal emergency device 300 or circumstance of using personal emergency device 300. For example, a user that is bedridden while recovering from surgery may have different combinations of characteristics that will be interpreted as an emergency alert than a user that is ambulatory.

The characteristics of device 100 that are used to interpret signals transmitted by device 100 may be modified by a user or a third party, such as an administrator. The characteristics may also include threshold or tolerance values that can be incorporated in the interpretation of the characteristics by receiver 102. The threshold values may prevent inadvertent or unintended interpretation of signals as emergency alerts. For example, an amount of movement of device 100 in excess of a predefined threshold value may be interpreted as an emergency alert, while an amount of movement of device 100 below the predefined threshold value may not be interpreted as an emergency alert. An exemplary threshold value may be based on acceleration. If movement is detected having an acceleration above half the rate of acceleration of a mass in free fall (e.g., 4.9 m/s²), then the movement may be interpreted as a user falling down, triggering an emergency response. Movements with an acceleration below that threshold may be interpreted as normal user activity. Also, a threshold value may be based on the number of user steps detected per unit time.

Similarly, a signal indicating an absence of movement of a device 100 may not require zero movement, but instead may be transmitted if movement of a device 100 is below a threshold value. The characteristics of location and time may also have threshold or tolerance values. For example, a location of device 100 within 5 feet of a particular zone may be interpreted as being within the zone. The threshold or tolerance values may be modified or eliminated depending on the particular use of personal emergency device 300.

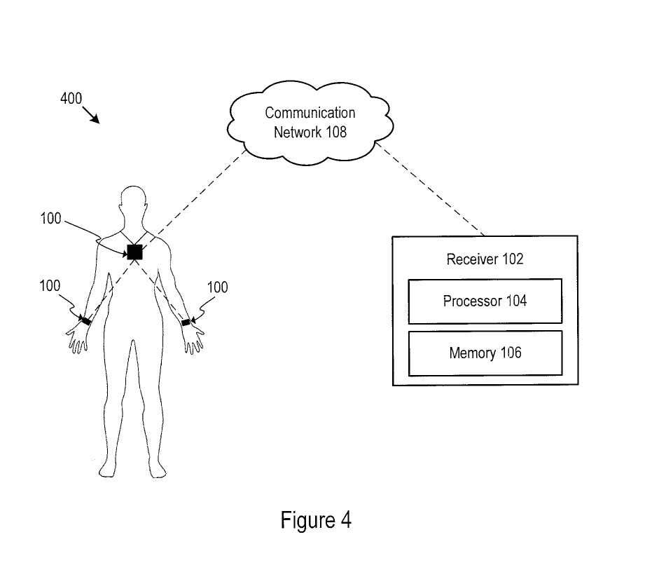

FIG. 4 is a diagram of exemplary personal emergency response system 400. Exemplary personal emergency response system 400 may include components previously described in reference to FIGS. 1A, 1B, 2, and 3. Personal emergency response system 400 may include receiver 102, communication network 108, and multiple devices 100. Devices 100 may be attached or worn on different parts of the users clothing or body. For example, personal emergency response system 400 includes a device 100 worn around the user's neck and a device 100 worn on each of a user's wrists. Each of devices 100 may be in wireless communication with the other devices 100. Each of devices 100 may also be in communication with receiver 102, as previously described.

Receiver 102 in personal emergency response system 400 may interpret signals transmitted by devices 100 based on additional characteristics of device 100, such as proximity of device 100 to other devices 100 attached to a user. Signals indicating close proximity of devices 100 for a predefined period of time may be interpreted as an emergency alert. The user may be aware that such proximity may be interpreted as an emergency alert and the user may be able to request assistance by intentionally causing such close proximity. Additionally or alternatively, signals indicating predefined movements of devices 100 in relation to other devices 100 may be interpreted as an emergency alert. For example, devices 100 located on a user's wrists moved close to a device 100 located on a user's chest for a period of time may signal a heart attack. The user may not be intentionally signaling an emergency alert by moving the devices 100 together in the example, but the devices 100 may be brought together by the user's natural reaction of clutching their chest during a heart attack. Other similar natural reactions of user's to other medical conditions may be interpreted as signaling emergency alerts. For example, rapid shaking of devices 100 may be interpreted as a seizure.

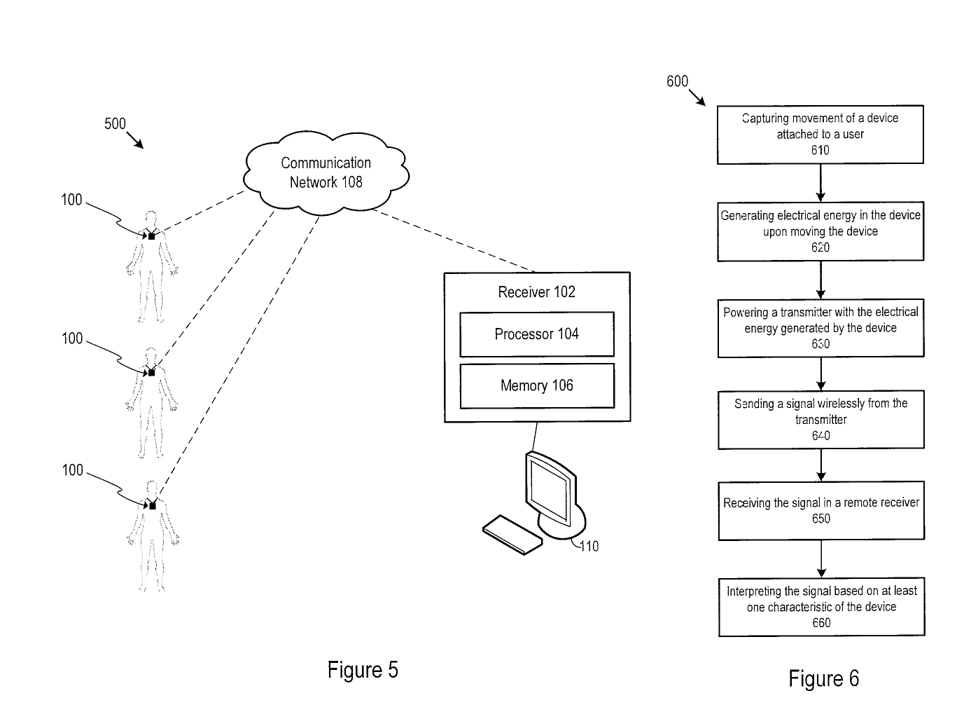

FIG. 5 is a schematic of another exemplary personal emergency response system 500. The exemplary personal emergency response system 500 may include components previously described in reference to FIG. 1A, 1B, 2, 3, or 4. Personal emergency response system 500 may include receiver 102, communication network 108, and multiple devices 100, with devices 100 associated with multiple users. Receiver 102 may receive signals from the multiple devices 100 and interpret the signals based on unique characteristics of each device 100. The unique characteristics may include, for example, a manner to identify a particular device 100, such as an identification name, identification number, or some other identification designator. Receiver 102 may interpret signals to identify each distinct user and track information including but not limited to location, time spent at or away from a specific location, movement, and emergency alert status.

Exemplary personal response system 500 may be utilized by users potentially in need of emergency assistance or may be utilized by emergency response personnel themselves. For example, police officers or firefighters may equip devices 100 on their persons. A remote receiver 102 may track location and time spent at or away from specific locations for multiple active emergency response persons simultaneously as each person's device 100 sends signals to receiver 102. For example, personal response system 500 may locate a firefighter in a burning building in low visibility based on signals generated from the firefighter's device 100. For an additional example, personal response system 500 may track the time spent by a police officer away from headquarters on patrol or at an incident site.

Any of the exemplary personal emergency response systems 1, 200, 300, 400, or 500 may be able to detect and transmit information regarding a user's medical conditions. Devices 100 may be equipped with sensors 160 as shown in FIG. 1B to detect a user's physical condition, such as for example, heart rate, pulse rate, blood pressure, body temperature, blood oxygen level, blood glucose level, brain activity, etc. Receiver 102 may be able to analyze the signal containing the physical condition and interpret the signal to determine the user's medical condition. Receiver 102 may signal an emergency alert based on the medical condition. The personal emergency response systems may be able to transmit an emergency alert based on a user's medical condition without the user triggering the emergency alert or without the user being aware of the medical condition. For example, personal emergency response system 400 may detect that a diabetic user's blood glucose level is abnormal and signal an emergency alert before the user knows that a medical emergency situation has arisen. As such, the personal emergency response systems may save valuable time in providing a user medical assistance.

Any of the exemplary personal emergency response systems 1, 200, 300, 400, or 500 may be able to communicate with other systems or devices. The personal emergency response devices may be able to transmit signals to issue commands or instructions to other devices. For example, commands may be sent to turn on a user's lights or unlock a user's doors when the personal emergency response systems determine that a device 100 attached to a user is nearing a user's home in the evening. Commands may be sent to communication devices, such as a user's phone, such that the communication device will alert designated individuals regarding the user's status. For example, the personal emergency response systems may command a user's phone to send a text message to a user's spouse if an emergency alert was sent from a user's personal emergency response system.

Any of the exemplary personal emergency response systems 1, 200, 300, 400, or 500 may be able to power additional devices upon generation of electric energy in device 100. A device 100 when activated may be able to power a locally connected emergency device. For example, emergency devices including but not limited to an audible alarm, flashlight, and heater may be powered using electric energy generated by device 100.

FIG. 6 is a flow diagram of a method for operating an exemplary personal emergency response system. Method 600 may be implemented as hardware, software, or both, for example in device 100, receiver 102, computer 110, or any combination. Method 600 may start at step 610 by capturing movement of a device attached to a user, where the device includes a switch, a generator, and a transmitter. A magnetic core, pendulum, or some other weight may capture the movement of the device. For example, when the device moves, the magnetic core captures that movement by moving through a coil of copper wire, or a pendulum begins to swing from a resting position. At step 620, the device may generate electrical energy as a result of the movement captured in step 610. At step 630, the electrical energy generated in step 620 may power a transmitter in the device. At step 640, the transmitter may send a wireless signal. The signal may be received by a receiver in step 650. After receiving the signal, in step 660 the receiver may interpret the signal based on a characteristic of the device.

Methods or processes may be implemented, for example, using a processor and/or instructions or programs stored in a memory. Specific components of the disclosed embodiments may include additional or different components. A processor may be implemented as a microprocessor, microcontroller, application specific integrated circuit (ASIC), discrete logic, or a combination of other types of circuits or logic. Similarly, memories may be DRAM, SRAM, Flash, or any other type of memory. Parameters, databases, and other data structures may be separately stored and managed, may be incorporated into a single memory or database, or may be logically and physically organized in many different ways. Programs or instruction sets may be parts of a single program, separate programs, or distributed across several memories and processors.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A personal emergency response system for attachment to a user, the system comprising:
an actuator coupled to a generator;
a transmitter connected to the generator;
wherein the generator is operable to generate electrical energy without the use of a battery to power the transmitter upon movement of the actuator;
wherein the transmitter is operable to send a signal wirelessly upon movement of the actuator;
a remote receiver that is operable to receive the signal from the transmitter, wherein the receiver interprets the signal based on at least one characteristic of the actuator.

2. The personal emergency response system of claim 1, wherein the characteristic of the actuator includes movement of the actuator.

3. The personal emergency response system of claim 2, wherein the receiver interprets the signal as an emergency alert when there is movement of the actuator.

4. The personal emergency response system of claim 2, wherein the receiver interprets the signal as an emergency alert when there is absence of movement of the actuator.

5. The personal emergency response system of claim 1, wherein the characteristics of the actuator include movement of the switch and location of the switch.

6. The personal emergency response system of claim 5, wherein the receiver interprets the signal as an emergency alert when there is movement of the actuator in a predefined location.

7. The personal emergency response system of claim 1, wherein the characteristics of the actuator include movement of the switch and time of receiving the signal.

8. The personal emergency response system of claim 7, wherein the receiver interprets the signal as an emergency alert when there is movement of the actuator during a predefined time period.

9. The personal emergency response system of claim 1, wherein the characteristics of the actuator include movement of the actuator and location of the actuator and time of receiving the signal and wherein the receiver interprets the signal as an emergency alert when there is movement of the actuator in a predefined location and during a predefined time period.

10. The personal emergency response system of claim 1, wherein the receiver utilizes configurable thresholds of the at least one characteristic of the actuator to interpret the signal.

11. The personal emergency response system of claim 11, wherein the configurable threshold includes movement of the actuator in excess of a predefined value and wherein the receiver interprets the signal as an emergency alert when movement of the actuator is in excess of the predefined value.

12. The personal emergency response system of claim 1, wherein the actuator is selected from a group consisting of a switch, pendulum, lug, or piezoelectric device.

13. The personal emergency response system of claim 1, wherein the actuator is a first actuator and further comprising a second actuator, wherein the characteristic of the first actuator is a predefined position of the first actuator relative to the second actuator, and wherein the receiver interprets the signal as an emergency alert when the first actuator is in the predefined position relative to the second actuator.

14. The personal emergency response system of claim 1, wherein the actuator is operable to detect a medical condition of the user and the transmitter is operable to send a signal regarding the medical condition.

15. The personal emergency response system of claim 1, wherein the characteristic of the actuator includes a unique characteristic.

16. The personal emergency response system of claim 1, further comprising a plurality of devices, each of the plurality of devices comprising a switch, a generator, and a transmitter, wherein the receiver is operable to receive signals from the plurality of devices and wherein the receiver interprets the signals as identifying distinct devices.

17. A method of operating a personal emergency response system attached to a user, the method comprising:
generating electrical energy upon movement of an actuator that is attached to a user;
powering a transmitter with the electrical energy;
sending a signal wirelessly from the transmitter;
receiving the signal in a remote receiver;
interpreting the signal in the remote receiver based on at least one characteristic of the actuator.

18. The method of operating a personal emergency response system attached to a user of claim 17, wherein the characteristic of the actuator includes movement of the actuator and wherein the receiver interprets the signal as an emergency alert when there is movement of the actuator.

19. The method of operating a personal emergency response system attached to a user of claim 17, wherein the characteristics of the actuator include movement of the actuator and location of the actuator and wherein the receiver interprets the signal as an emergency alert when there is movement of the actuator in a predefined location.

20. The method of operating a personal emergency response system attached to a user of claim 17, wherein the characteristics of the actuator include movement of the actuator and time of receiving the signal and wherein the receiver interprets the signal as an emergency alert when there is movement of the actuator during a predefined time period.
